(19) United States
(12) Patent Application Publication
(10) Pub. No.: US 2024/0135714 A1
(43) Pub. Date: Apr. 25, 2024

(54) SYSTEM AND METHOD FOR CLASSIFYING TASK

(71) Applicant: 3M INNOVATIVE PROPERTIES COMPANY, St. Paul, MN (US)

(72) Inventors: John W. Henderson, St. Paul, MN (US); Sophia S. Liu, Denver, CO (US); Andrew W. Long, Woodbury, MN (US); Jordan J.W. Craig, White Bear Lake, MN (US)

(21) Appl. No.: 18/383,279

(22) Filed: Oct. 23, 2023

Related U.S. Application Data
(60) Provisional application No. 63/418,907, filed on Oct. 24, 2022.

(51) Int. Cl. G06V 20/52; G06V 10/764; G06V 20/70

(52) U.S. Cl. CPC G06V 20/52; G06V 10/764; G06V 20/70

(57) ABSTRACT

A method of classifying a task includes obtaining a plurality of images via an image capturing device and an audio signal via an audio sensor for a predetermined period of time. The method further includes classifying, via a first trained machine learning model, the plurality of images to generate a list of first class probabilities and a list of first class labels. The method further includes classifying, via a second trained machine learning model, the audio signal to generate a list of second class probabilities and a list of second class labels. The method further includes determining, via a merging algorithm, a list of third class probabilities and a list of third class labels based on the lists of first and second class probabilities. The method further includes determining the task corresponding to the predetermined period of time based on the list of third class probabilities.

### TECHNICAL FIELD

The present disclosure relates to a system and a method for classifying a task. More specifically, the present disclosure relates to system and a method for classifying a task in a workplace.

### BACKGROUND

Many workplaces, such as vehicle repair and maintenance shops, production plants, etc. may include a variety of tasks performed within the workplace. Numerous systems exist for calculating various performance metrics (e.g., revenue, throughput, expenses, profitability, efficiency, etc.) of such workplaces, however, no solution exists for automatically populating an underlying data required (e.g., the number and type of tasks performed, a time required for performing each task). For example, a full understanding of a work process flow (hours per task, hands-on time per task, down time, time spent waiting for parts, bottlenecks, mean cycle time, etc.) may be required for calculation of such performance metrics. Current systems require manually inputting the underlying data, which may be difficult in a fast-paced, multi-step, and manual workflow. Additionally, in order to accurately identify areas for improvement, a granular breakdown of the work process flow throughout the workplace may be required. This may be difficult especially when the tasks are performed at various physical locations within the workplace.

### SUMMARY

In one aspect, a method of classifying a task in a workplace is described. The method includes obtaining, via at least one image capturing device, a plurality of images for a predetermined period of time. The method further includes obtaining, via at least one audio sensor, an audio signal corresponding to the predetermined period of time. The method further includes classifying, via a first trained machine learning model, the plurality of images to generate a list of first class probabilities and a list of first class labels corresponding to the list of first class probabilities. Each first class probability is indicative of a probability of the corresponding first class label being the task. The method further includes classifying, via a second trained machine learning model, the audio signal to generate a list of second class probabilities and a list of second class labels corresponding to the list of second class probabilities. Each second class probability is indicative of a probability of the corresponding second class label being the task. The method further includes determining, via a merging algorithm, a list of third class probabilities and a list of third class labels corresponding to the list of third class probabilities based at least on the list of first class probabilities and the list of second class probabilities. Each third class probability is indicative of a probability of the corresponding third class label being the task. The method further includes determining, via a processor, the task corresponding to the predetermined period of time based at least on the list of third class probabilities.

In another aspect, a system for classifying a task in a workplace is described. The system includes at least one image capturing device configured to capture a plurality of images for a predetermined period of time. The system further includes at least one audio sensor configured to capture sound waves corresponding to the predetermined period of time and generate an audio signal based on the captured sound waves. The system further includes a processor communicably coupled to the at least one image capturing device and the at least one audio sensor. The processor is configured to obtain the plurality of images from the at least one image capturing device and the audio signal from the at least one audio sensor. The system further includes a first trained machine learning model communicably coupled to the processor. The first trained machine learning model is configured to classify the plurality of images to generate a list of first class probabilities and a list of first class labels corresponding to the list of first class probabilities. Each first class probability is indicative of a probability of the corresponding first class label being the task. The system further includes a second trained machine learning model communicably coupled to the processor. The second trained machine learning model is configured to classify the audio signal to generate a list of second class probabilities and a list of second class labels corresponding to the list of second class probabilities. Each second class probability is indicative of a probability of the corresponding second class label being the task. The system further includes a merging algorithm communicably coupled to the processor. The merging algorithm is configured to generate a list of third class probabilities and a list of third class labels corresponding to the list of third class probabilities based at least on the list of first class probabilities and the list of second class probabilities. Each third class probability is indicative of a probability of the corresponding third class label being the task. The processor is further configured to determine the task corresponding to the predetermined period of time based at least on the list of third class probabilities.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 illustrates a schematic view of a system for classifying a task in a workplace, in accordance with techniques of this disclosure;

FIG. 2 is a block diagram illustrating an example of the system of FIG. 1, in accordance with techniques of this disclosure;

FIG. 3 is a block diagram illustrating an example of the system of FIG. 2, in accordance with techniques of this disclosure;

FIG. 4 is a block diagram illustrating another example of the system of FIG. 2, in accordance with techniques of this disclosure;

FIG. 5A is a flow chart illustrating a method for training a first trained machine learning model, in accordance with techniques of this disclosure;

FIG. 5B is a flow chart illustrating a method for training a second trained machine learning model, in accordance with techniques of this disclosure; and

FIG. 6 is a flow chart illustrating a method for of classifying the task in the workplace, in accordance with techniques of this disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

According to aspects of this disclosure, a method of classifying a task in a workplace includes obtaining, via at least one image capturing device, a plurality of images for a predetermined period of time. The method further includes obtaining, via at least one audio sensor, an audio signal corresponding to the predetermined period of time. The method further includes classifying, via a first trained machine learning model, the plurality of images to generate a list of first class probabilities and a list of first class labels corresponding to the list of first class probabilities. Each first class probability is indicative of a probability of the corresponding first class label being the task. The method further includes classifying, via a second trained machine learning model, the audio signal to generate a list of second class probabilities and a list of second class labels corresponding to the list of second class probabilities. Each second class probability is indicative of a probability of the corresponding second class label being the task. The method further includes determining, via a merging algorithm, a list of third class probabilities and a list of third class labels corresponding to the list of third class probabilities based at least on the list of first class probabilities and the list of second class probabilities. Each third class probability is indicative of a probability of the corresponding third class label being the task. The method further includes determining, via a processor, the task corresponding to the predetermined period of time based at least on the list of third class probabilities.

The method may allow automatic identification of the task within the workplace based on the classification of the plurality of images and the audio signal. This may reduce a need to manually register/input data associated with the tasks performed within the workplace. The first trained machine learning model and the second trained machine learning model may generate the list of first class labels and the list of second class labels with the associated first class probabilities and the second class probabilities, respectively. The merging algorithm may then determine the list of third class labels and the list of third class probabilities based at least on the list of first class probabilities and the list of second class probabilities. Thus, the method may allow accurate identification of the task within the workplace based on multiple inputs, i.e., via the classification of the plurality of images and the classification of the audio signal.

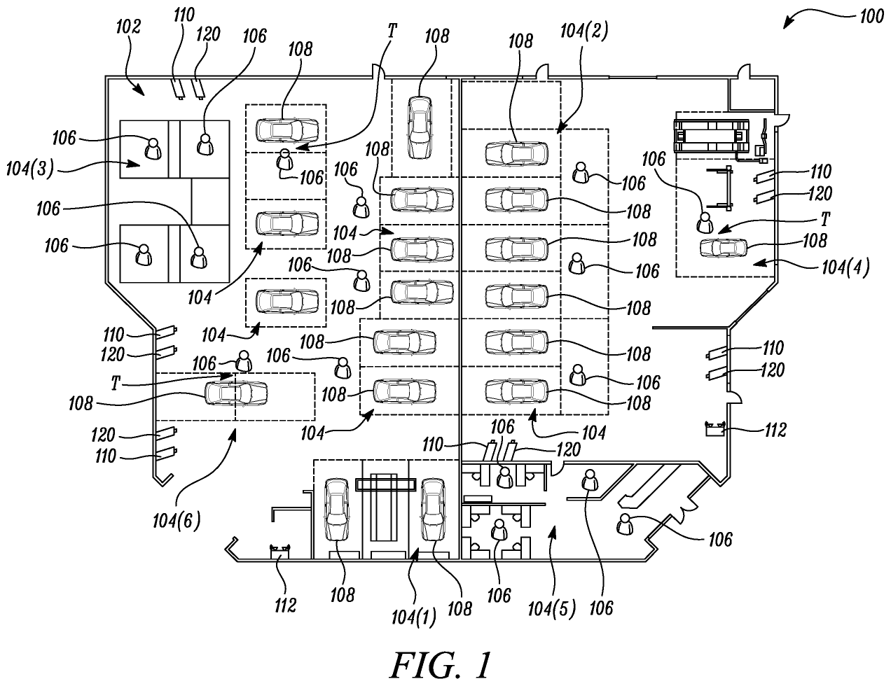

FIG. 1 illustrates a schematic view of an example of a system 100 for classifying a task T in a workplace 102. The workplace 102 may be a vehicle repair and/or maintenance facility (e.g., where repair or maintenance activities are performed on vehicles). In some examples, the workplace 102 includes a plurality of zones 104(1), 104(2), . . . , 104(N) (collectively referred to as the “zones 104”), where N is an integer corresponding to a total number of zones 104 within the workplace 102 (e.g., N=1, 2, 3, etc.). In some examples, each zone 104(1)-104(N) may be associated with an area/region within the workplace 102. For example, the zone 104(1) may be associated with a paint booth, the zone 104(2) may be a body repair work stall, the zone 104(3) may be a spare parts storage area, the zone 104(4) may be a vehicle wash area, the zone 104(5) may be an administrative area, the zone 104(6) may be an area where the vehicles are parked when entering the workplace 102.

In some examples, the workplace 102 further includes one or more workers 106 for performing the task T within the workplace 102. In some examples, the workplace 102 further includes one or more vehicles 108. Specifically, the one or more workers 106 may perform the task T on the one or more vehicles 108 within the workplace 102. Examples of the tasks T performed within the workplace 102 may include, but are not limited to, sheet metal operations, dent removal or dent repair operation, painting, polishing, wheel alignment/balancing, engine maintenance, transmission maintenance, suspension repair, etc. In some examples, activity such as painting may include multiples subtasks, e.g., body preparation, paint preparation, paint finishing, inspection, etc. that may also be referred to as the tasks T. Further, the tasks T may be performed within the zones 104(1)-104(N).

The system 100 includes at least one image capturing device 110. In some examples, the at least one image capturing device 110 includes multiple image capturing devices 110 that are disposed at multiple locations within the workplace 102. For example, the at least one image capturing device 110 may be positioned such that the at least one image capturing device 110 may be able to capture image(s) associated with the entire workplace 102. Alternatively, in some examples, the at least one image capturing device 110 may be disposed on the worker 106 itself. The term “at least one image capturing device 110” is interchangeably referred to hereinafter as the “image capturing device 110”.

In some examples, the image capturing device 110 may be any means capable of generating, storing, processing, and/or providing information associated with an image, a set of images, and/or a video. For example, the image capturing device 110 may include one or more cameras (e.g., one or more digital video cameras, still image cameras, infrared cameras, etc.). In some examples, each zone 104(1)-104(N) may include the image capturing device 110 associated with the zone 104(1)-104(N). In some examples, the image capturing device 110 may capture images related to the workers 106 within the workplace 102, the tasks T being performed within the workplace 102, and/or objects (e.g., the vehicle 108, a license plate of the vehicle 108, an equipment, etc.) within the workplace 102.

In some examples, the image capturing device 110 may be capable of sending and receiving data by way of one or more wired and/or wireless communication interfaces. In some examples, the wireless communication interface may communicate data via one or more wireless communication protocols, such as Bluetooth, infrared, Wi-Fi, WiMax, cellular communication (3G, 4G, LTE, 5G), wireless universal serial bus (USB), radio frequency, near-field communication (NFC), private licensed bands, or generally any wireless communication protocol. In some examples, the workplace 102 includes a plurality of wireless access points 112 that may be geographically distributed throughout the workplace 102 to provide support for wireless communications throughout the workplace 102.

The system 100 further includes at least one audio sensor 120. In some examples, the at least one audio sensor 120 includes multiple audio sensors 120 that are disposed at multiple locations within the workplace 102. For example, the at least one audio sensor 120 may be positioned such that the at least one audio sensor 120 may be able to capture sound(s) associated with the entire workplace 102. In some examples, the at least one audio sensor 120 may also be disposed on or within the image capturing device 110. In some examples, the at least one audio sensor 120 may be directly or indirectly coupled to the image capturing device 110. The term “at least one audio sensor 120” is interchangeably referred to hereinafter as the “audio sensor 120”.

In some examples, the audio sensor 120 may be any means capable of generating, storing, processing, and/or providing information associated with sound(s) in the workplace 102. For example, the audio sensor 120 may include one or more microphones configured to capture sound(s) in the workplace 102. In some examples, each zone 104(1)-104(N) may include the audio sensor 120 associated with the zone 104(1)-104(N). In some examples, the audio sensor 120 may capture sound(s) related to the tasks T being performed within the workplace 102, e.g., sound(s) produced due to interaction between a tool and the one or more vehicles 108.

In some examples, the audio sensor 120 may be capable of sending and receiving data by way of one or more wired and/or wireless communication interfaces. In some examples, the wireless communication interface may communicate data via one or more wireless communication protocols, such as Bluetooth, infrared, Wi-Fi, WiMax, cellular communication (3G, 4G, LTE, 5G), wireless universal serial bus (USB), radio frequency, near-field communication (NFC), private licensed bands, or generally any wireless communication protocol.

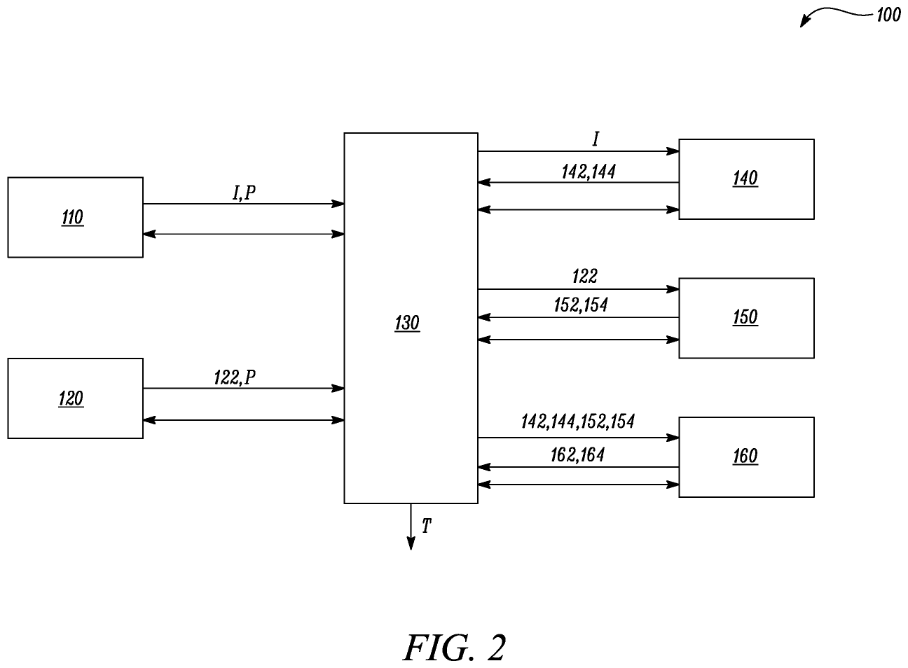

FIG. 2 is a block diagram illustrating an example of the system 100. Referring now to FIGS. 1 and 2, the at least one image capturing device 110 is configured to capture a plurality of images I for a predetermined period of time P. For example, the at least one image capturing device 110 may capture the plurality of images I associated with the vehicles 108, the workers 106, and/or equipment, and/or vehicles within the workplace 102, entering the workplace 102, leaving the workplace 102, moving within the workplace 102, and/or the like. In some examples, the image capturing device 110 may capture information such as the license plate of the vehicle 108, a serial number of the equipment, a part number of supplies, a make/model of the vehicle 108, and work gear associated with the worker 106, etc.

Further, the plurality of images I images may be associated with particular areas/regions (i.e., the zones 104) within the workplace 102 (e.g., the spare parts storage area, etc.), the tasks T being carried out by the workers 106 (e.g., maintenance activities, movement through the workplace 102), and/or the like. In some examples, the at least one image capturing device 110 may capture a video (e.g., multiple images that appear to form continuous motion, a video stream, etc.). The term “plurality of images I” is referred to hereinafter as the “images I”. In some examples, the predetermined period of time P may represent a minimum time period in which the task T may be identified. Further, in some examples, a value of the predetermined period of time P may determine granular breakdown of an entire workflow the vehicle 108 may undergo in the workplace 102.

The at least one audio sensor 120 is configured to capture sound waves corresponding to the predetermined period of time P and generate an audio signal 122 corresponding to the captured sound waves. The audio signal 122 may represent an audio or sound picked up by the at least one audio sensor 120 in response to the task T being performed within the workplace 102. For example, an interaction between the tool and the vehicle 108 (e.g., a hammer blow, grinding, spraying using a paint spray gun, drilling, mixing, tearing, etc.) may generate a sound which may be captured by the at least one audio sensor 120. Alternatively, or additionally, the at least one audio sensor 120 may also generate the audio signal 122 corresponding to the predetermined period of time P even if no sound is produced within the workplace 102 indicating an empty event (e.g., idle time) associated with the predetermined period of time P. Further, the audio sensor 120 may operate in conjunction with the image capturing device 110, such that the audio sensor 120 and the image capturing device 110 may simultaneously record the task T being performed within the workplace 102 corresponding to the predetermined period of time P.

The system 100 further includes a processor 130 communicably coupled to the at least one image capturing device 110 and the at least one audio sensor 120. The processor 130 is configured to obtain the plurality of images I from the at least one image capturing device 110 and the audio signal 122 from the at least one audio sensor 120. In some examples, the processor 130 may further receive information related to timestamps of the images I and/or the audio signal 122.

In some examples, the processor 130 may be embodied in a number of different ways. For example, the processor 130 may be embodied as various processing means, such as one or more of a microprocessor or other processing elements, a coprocessor, or various other computing or processing devices, including integrated circuits, such as, for example, an ASIC (application specific integrated circuit), an FPGA (field programmable gate array), or the like. In some examples, the processor 130 may be configured to execute instructions stored in a memory (not shown) or otherwise accessible to the processor 130. In some examples, the memory may include a cache or random-access memory for the processor 130. Alternatively, or in addition, the memory may be separate from the processor 130, such as a cache memory of the processor 130, a system memory, or other memory.

As such, whether configured by hardware or by a combination of hardware and software, the processor 130 may represent an entity (e.g., physically embodied in a circuitry—in the form of a processing circuitry) capable of performing operations according to some embodiments while configured accordingly. Thus, for example, when the processor 130 is embodied as an ASIC, FPGA, or the like, the processor 130 may have specifically configured hardware for conducting the operations described herein. Alternatively, as another example, when the processor 130 may be embodied as an executor of software instructions, the instructions may specifically configure the processor 130 to perform the operations described herein.

In some examples, the processor 130 may include a memory (not shown). In some examples, the memory may be configured to store data, such as the images I, the audio signal 122, software, audio/video data, etc. The functions, acts or tasks illustrated in the figures or described herein may be performed by the processor 130 executing the instructions stored in the memory. The functions, acts or tasks may be independent of a particular type of instruction set, a storage media, a processor or processing strategy and may be performed by a software, a hardware, an integrated circuit, a firmware, a micro-code and/or the like, operating alone or in combination. Likewise, the processing strategies may include multiprocessing, multitasking, parallel processing, and/or the like.

In some examples, the memory may be a main memory, a static memory, or a dynamic memory. The memory may include, but may not limited to, computer readable storage media, such as various types of volatile and non-volatile storage media, including, but not limited to, random access memory (RAM), read-only memory (ROM), programmable read-only memory, electrically programmable read-only memory (EPROM), electrically erasable programmable read-only memory (EEPROM), flash memory, magnetic tape or disk, optical media, and/or the like.

The system 100 further includes a first trained machine learning model 140 communicably coupled to the processor 130. The first trained machine learning model 140 is configured to classify the plurality of images I to generate a list of first class probabilities 142 and a list of first class labels 144 corresponding to the list of first class probabilities 142. Each first class probability 142 is indicative of a probability of the corresponding first class label 144 being the task T. In some examples, the first trained machine learning model 140 may receive the plurality of images I in real-time or near real-time (e.g., as the images I are captured by the image capturing device 110).

In some examples, the first trained machine learning model 140 may include instructions for probabilistic classifications of the plurality of images I. For example, the first trained machine learning model 140 may include instructions for probabilistically classifying the images I using machine learning algorithms, e.g., neural network pattern recognition techniques, etc. Other algorithms used by the first trained machine learning model 140 may include support vector machines (SVMs) method, artificial neural network (ANN), AdaBoost, random forest, etc. In some examples, the first trained machine learning model 140 may be hosted in a cloud computing environment. Alternatively, in some examples, the first trained machine learning model 140 may not be cloud-based (i.e., may be implemented outside of the cloud computing environment or on a local computer) or may be partially cloud-based.

In some examples, the cloud computing environment may provide computation, software, data access, storage, etc. services that do not require end-user knowledge of a physical location and configuration of system(s) and/or device(s) that host the first trained machine learning model 140. In some examples, the cloud computing environment may include a group of computing resources. In some examples, the computing resources may include one or more personal computers, workstation computers, server devices, or other types of computation and/or communication devices.

In some examples, the first trained machine learning model 140 may analyze the plurality of images I to detect the tools/objects within the plurality of images I and subsequently classify the images I to generate the list of first class labels 144 and the corresponding list of first class probabilities 142. For example, the first trained machine learning model 140 may process the images I to identify the workers 106 (e.g., the workers 106, other staff members, etc.) in the workplace 102, the objects (e.g., the equipment/tools, etc.) in the workplace 102, the task T being performed within the workplace 102, and/or the like, to classify the plurality of images I. This may allow the first trained machine learning model 140 to generate the list of first class labels 144 based on the processed images I.

In some examples, the first trained machine learning model 140 may utilize image processing techniques, e.g., a fuzzy logic image processing technique, a computer vision technique, a shape detection technique, a technique that includes use of a color histogram, a motion detection technique, and/or the like to classify the images I. For example, a paint suit worn by the worker 106 in the workplace 102 may include a color histogram and the first trained machine learning model 140 may identify the paint suit, or the worker 106 wearing the paint suit, by identifying the color histogram of the paint suit. Other examples may include respiratory equipment, safety glasses, and/or the like. In some examples, the first trained machine learning model 140 may have been trained previously to identify the objects (e.g., tools of a specific shape, size, or color), the workers 106, the tasks T, etc. in the images I.

In some examples, the first trained machine learning model 140 may process the images I to correct the images I for distortion, warping, edge bending, and/or the like (e.g., because of an angle of the image capturing device 110 relative to the worker 106, the objects, and/or the task T in the workplace 102 or the zone 104) to improve processing of the images I. In some examples, the first trained machine learning model 140 may normalize the images I from different image capturing device 110 when processing the images I. For example, the image capturing device 110 may be positioned at different heights (e.g., on a wall, above a floor, on a ceiling, etc.), may have different degrees of angle, may have overlapping fields of view, and/or the like. This may allow the first trained machine learning model 140 to classify the images I based on the identified objects, the tasks T, and/or the workers 106 in the images I from different image capturing devices 110.

In some examples, the first trained machine learning model 140 may process the images I using an algorithm to identify text in the images I (e.g., the license plate of the vehicle 108) to identify the vehicle 108 on which the task T is being performed. Further, the first trained machine learning model 140 may be able to identify whether the vehicle 108 and/or a type of the vehicle 108 is present in the workplace 102 based on such processing. In some examples, the first trained machine learning model 140 may identify the vehicle 108 being worked on based on a vicinity of the worker 106 with respect to the vehicle 108 in the workplace 102 or in a particular zone 104 of the workplace 102.

In some examples, the first trained machine learning model 140 may process the image I to identify the objects (e.g., the vehicle 108 on which the task T is being performed, the tool being used to perform the task T, particular types of the vehicles 108, etc.). In some examples, the first trained machine learning model 140 may process the image I to identify a shape, a color, a size, etc. of the objects in the images I. For example, the first trained machine learning model 140 may identify the objects using a computer vision technique, a shape detection technique, a feature extraction technique, and/or the like.

In some examples, the first trained machine learning model 140 may process the images I to identify the workers 106, or other individuals such as a supervisor, within the workplace 102 or the zones 104. In some examples, the first trained machine learning model 140 may identify the workers 106 based on a characteristic, such as a shape, a color, a skin color, a height, a hair color, a uniform, and/or the like of the worker 106. Additionally, or alternatively, the first trained machine learning model 140 may identify a particular worker 106 in the images I by using a facial recognition technique, by detecting a worker identifier (e.g., an employee identification number that identifies the worker 106), and/or the like.

In some examples, the first trained machine learning model 140 may process the images I to identify the task T (e.g., a repair/maintenance activity, movement of the worker 106 and/or the objects within the workplace 102 or zones 104, etc.). For example, the first trained machine learning model 140 may identify the task T by detecting a combination of the tool and the worker 106 (e.g., by detecting the tool possessed by the worker 106 using a shape detection technique, a feature extraction technique, etc.). Additionally, or alternatively, the first trained machine learning model 140 may detect the task T by detecting a particular motion in the plurality of images I (e.g., using a motion feature extraction technique).

In some examples, the first trained machine learning model 140 may generate the list of first class labels 144 based on the probabilistic determination of the task T (e.g., through processing of the images I) in the workplace 102 or the zone 104. Each first class label 144 is associated with a corresponding first class probability 142 indicating the probability of the first class label 144 being the task T. In other words, the first class probability 142 may indicate a confidence level or a likelihood that the task T is correctly identified (based on the identification of the objects, the workers 106, etc.). In some examples, the first trained machine learning model 140 may determine the first class probability 142 based on a degree to which the identified worker 106, the object, and/or the task T matches a training image (through which the first trained machine learning model 140 may be initially trained). Thus, the first trained machine learning model 140 may automatically generate the list of first class labels 144 that potentially be the task T.

In some examples, the first trained machine learning model 140 may combine information from multiple image capturing devices 110 for the predetermined period of time P to improve an accuracy of classification of the images I. For example, the first trained machine learning model 140 may identify the same worker 106, the same vehicle 108, and/or the same task T in the images I from different image capturing devices 110 to improve accuracy of the classification.

In some examples, the first trained machine learning model 140 may alternatively be trained in a guided manner. For example, a user may manually verify and/or correct a result of the first trained machine learning model 140 processing the images I. In this case, the first trained machine learning model 140 may utilize user inputs related to verifying and/or correcting the result of processing the images I to improve future processing.

The system 100 further includes a second trained machine learning model 150 communicably coupled to the processor 130. The second trained machine learning model 150 is configured to classify the audio signal 122 to generate a list of second class probabilities 152 and a list of second class labels 154 corresponding to the list of second class probabilities 152. Each second class probability 152 is indicative of a probability of the corresponding second class label 154 being the task T.

In some examples, the second trained machine learning model 150 may be hosted in a cloud computing environment. Alternatively, in some examples, the second trained machine learning model 150 may not be cloud-based (i.e., may be implemented outside of the cloud computing environment or on a local computer) or may be partially cloud-based.

In some examples, the second trained machine learning model 150 may apply audio processing techniques (e.g., a feature extraction technique) on the audio signal 122 before generating the list of second class labels 154 and the list of second class probabilities 152. In some examples, the feature extraction technique may be wavelet-based. For example, the second trained machine learning model 150 may break the audio signal 122 into a set of wavelet coefficients which may then be compared with specific audio signatures of different tasks. In some examples, the feature extraction technique may be based on Fourier transform (including spectrogram). In some examples, the feature extraction technique may be based on scalable hypothesis tests for a time-series data (e.g., FRESH—FeatuRe Extraction based on Scalable Hypothesis tests). In some examples, the feature extraction technique may be based on learned convolutional filters.

The second trained machine learning model 150 may then classify the audio signal 122 to generate the list of second class labels 154 and the associated list of second class probabilities 152. Each second class label 154 is associated with a corresponding second class probability 152 indicating the probability of the second class label 154 being the task T. In some examples, the second trained machine learning model 150 may determine the second class probability 152 based on a degree to which the audio signal 122 matches a training audio signal (through which the second trained machine learning model 150 may be initially trained). Thus, the second trained machine learning model 150 may automatically generate the list of second class labels 154 that potentially be the task T.

Additionally, or alternatively, the second trained machine learning model 150 may be trained in a guided manner. For example, a user may manually verify and/or correct a result of the second trained machine learning model 150 processing the audio signals 122. In this case, the second trained machine learning model 150 may utilize user inputs related to verifying and/or correcting the result of processing the audio signals 122 to improve future processing.

The first and second machine learning model 140, 150 may then transmit the lists of first and second class labels 144, 154 and the corresponding lists of first and second class probabilities 142, 152 to the processor 130. The system 100 further includes a merging algorithm 160 communicably coupled to the processor 130. The merging algorithm 160 is configured to generate a list of third class probabilities 162 and a list of third class labels 164 corresponding to the list of third class probabilities 162 based at least on the list of first class probabilities 142 and the list of second class probabilities 152. Each third class probability 162 is indicative of a probability of the corresponding third class label 164 being the task T. In some examples, the merging algorithm 160 may include sub-algorithms.

In some examples, the merging algorithm 160 may generally refer to a set of instructions, or procedures, or formulas, for comparing two lists. In other words, the merging algorithm 160 may generate the list of third class probabilities 162 through application of the set of instructions, or procedures, or formulas, at least on the list of first class probabilities 142 and the list of second class probabilities 152. In some examples, the merging algorithm 160 may include a machine learning model capable of learning a function that outputs the list of third class probabilities 162 and the corresponding list of third class labels 164.

In some examples, the merging algorithm 160 may generate the list of third class probabilities 162 by performing a weighted combination of the list of first class probabilities 142 and the list of second class probabilities 152 (also known as additive blending). For example, a suitable weight may be selected for generating a weighted sum of the list of first class probabilities 142 and the list of second class probabilities 152 across the list of first class labels 144 and the list of second class labels 154. In some examples, the weight may be selected based on prior knowledge of output from the first trained machine learning model 140 and the second trained machine learning model 150. In some examples, the weight may be learned via regression or may be selected to evenly weight both the list of first class probabilities 142 and the list of second class probabilities 152.

In some examples, the merging algorithm 160 may generate the list of third class probabilities 162 by multiplying (or normalizing) the list of first class probabilities 142 and the list of second class probabilities 152 (also known as multiplicative blending). Such an algorithm may favor the scenario where one or more class labels are present in both the list of first class labels 144 and the list of second class labels 154 over the scenario where a class label is strongly predicted by one of the models while the other model weakly predicts that class label.

In some examples, the merging algorithm 160 may generate the list of third class probabilities 162 by utilizing statistical parameters. For example, the list of first class labels 144 may be ranked based on the corresponding list of first class probabilities 142. Similarly, the list of second class labels 154 may be ranked based on the corresponding list of second class probabilities 152. The merging algorithm 160 may determine an average rank (i.e., a mean rank) of each class label present in both the list of first class labels 144 and the list of second class labels 154 or an average probability of the corresponding class label. The merging algorithm 160 may then keep the top class labels (e.g., based on the average rank or the average probability) as the list of first class labels 144.

In some examples, the merging algorithm 160 may generate the list of third class labels 164 by comparing the list of first class probabilities 142 and the list of second class probabilities 152. In some examples, the merging algorithm 160 may generate the list of third class labels 164 by keeping all the first class labels 144 and the second class labels 154 having the corresponding first class probabilities 142 and the second class probabilities 152 above a predetermined threshold. The probabilities corresponding to the first class labels 144 and the second class labels 154 that are chosen may represent the list of third class probabilities 162. Alternatively, in some examples, the merging algorithm 160 may keep the class labels that are common between the list of first class labels 144 and the list of second class labels 154. In such cases, the common class labels may be regarded as the list of third class labels 164. Further, the probabilities corresponding to the first class labels 144 and the second class labels 154 that are chosen may represent the list of third class probabilities 162.

In some examples, the merging algorithm 160 transmits the list of third class probabilities 162 and the list of third class labels 164 to the processor 130. The processor 130 is further configured to determine the task T corresponding to the predetermined period of time P based at least on the list of third class probabilities 162. For example, the processor 130 may determine the task T based on the third class label 164 having the highest third class probability 162. In some other examples, the processor 130 may determine the task T based on the third class label 164 having the highest average rank calculated from the individual ranks in the list of first class labels 144 and the list of second class labels 154. In some examples, the processor 130 may combine timestamp related information with the determined task T to determine an amount of time required by the task T for completion or execution.

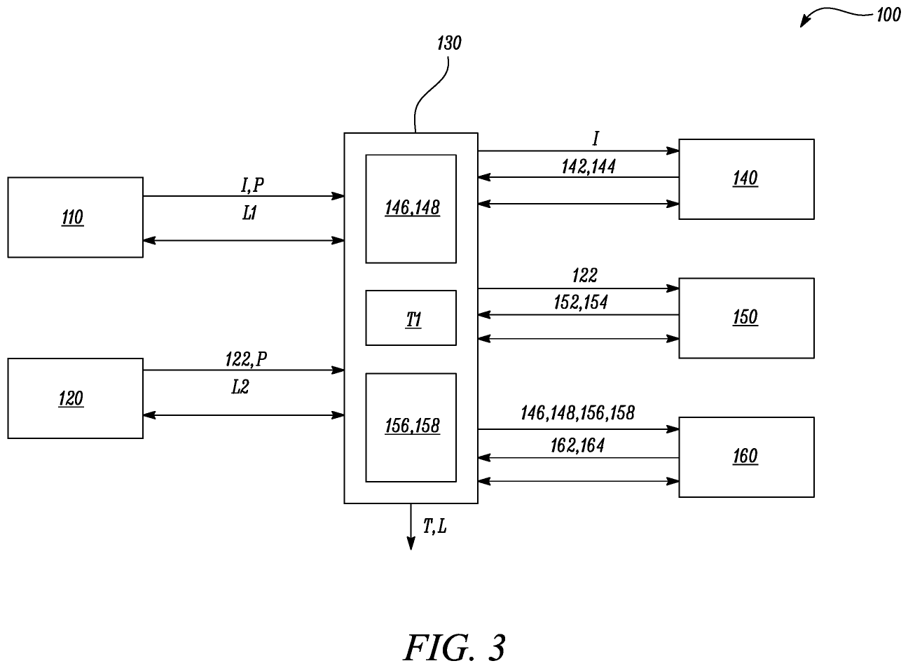

FIG. 3 is a block diagram illustrating another example of the system 100. Referring to FIGS. 1 and 3, in some examples, the processor 130 is further configured to determine a location L of the task T within the workplace 102 or the zones 104. In some examples, the location L includes the plurality of zones 104 (shown in FIG. 1). In some examples, the processor 130 is further configured to determine the location L of the task T within the workplace 102 or the zones 104 based on a predetermined location L1 of the at least one image capturing device 110 and/or a predetermined location L2 of the at least one audio sensor 120. In some examples, the image capturing device 110 and/or the audio sensor 120 may transmit their respective predetermined location L1, L2 to the processor 130.

Alternatively, or additionally, the processor 130 may determine the location L of the task T based on processing of the images I performed by the first trained machine learning model 140. For example, the first trained machine learning model 140 may determine the location L of the task T based on the feature extraction technique, e.g., by identifying unique tags/identifiers associated with a particular location L in the workplace 102 or the zones 104. For example, each zone 104 may include a name plate describing the name of that location L. Such name plates may be captured by the image capturing device 110 and may be identified by the first trained machine learning model 140. The first trained machine learning model 140 may then transmit this information to the processor 130.

In some examples, the processor 130 may determine the location L of the task T within the workplace 102 or the zones 104 based on inputs from other data sources, e.g., radio frequency identification (RFID) tags associated with the vehicles 108, maintenance schedule of the workplace 102 or the zones 104, etc. For example, the vehicles 108 may be associated with the RFID tag that may be read by a tag reader disposed at various locations in the workplace 102. Such tag readers may be communicably coupled to the processor 130.

In some examples, the processor 130 is further configured to determine a plurality of predetermined tasks T1 performable within the location L. In some examples, the processor 130 may store a list of potential tasks performable within predetermined locations in the workplace 102 or the zones 104. For example, a painting operation may only be performed within a paint booth (e.g., the zone 104(1)), dent repair may be performed in designated body repair work stalls (e.g., the zone 104(2)), etc. Thus, the processor 130 may determine the predetermined tasks T1 performable within the location L based on the stored data and the predetermined locations L1, L2 of the image capturing device 110 and the audio sensor 122, respectively.

In some examples, the processor 130 is further configured to determine the task T corresponding to the predetermined period of time P further based on an overlap between the list of third class labels 164 and the plurality of predetermined tasks T1 performable within the location L. This may reduce a processing required by the processor 130 in determining the task T corresponding to the predetermined period of time P.

In some examples, the processor 130 is further configured to modify the list of first class labels 144 and the list of first class probabilities 142 received from the first trained machine learning model 140 by removing one or more first class labels 144 from the list of first class labels 144 that are absent in the plurality of predetermined tasks T1 performable within the location L and removing the corresponding one or more first class probabilities 142 from the list of first class probabilities 142. Thus, the processor 130 may remove the one or more first class labels 144 from the list of first class labels 144 that may not be performable at the location L of the task T based on the plurality of predetermined tasks T1, thereby reducing the list of first class labels 144 to a modified list of first class labels 148 and the corresponding list of first class probabilities 142 to a modified list of first class probabilities 146. This may further reduce the processing required by the processor 130 in determining the task T corresponding to the predetermined period of time P.

In some examples, the processor 130 is further configured to provide the modified list of first class labels 148 and the modified list of first class probabilities 146 to the merging algorithm 160 prior to determination of the list of third class probabilities 162 and the list of third class labels 164. The merging algorithm 160 determines the list of third class probabilities 162 and the list of third class labels 164 based at least on the modified list of first class probabilities 146. Thus, the merging algorithm 160 may consider the modified list of first class probabilities 146 and the modified list of first class labels 148 for generating the list of third class probabilities 162 and the list of third class labels 164.

Similarly, in some examples, the processor 130 is further configured to modify the list of second class labels 154 and the list of second class probabilities 152 received from the second trained machine learning model 150 by removing one or more second class labels 154 from the list of second class labels 154 that are absent in the plurality of predetermined tasks T1 performable within the location L and removing the corresponding one or more second class probabilities 152 from the list of second class probabilities 152. Thus, the processor 130 may remove the one or more second class labels 154 from the list of second class labels 154 that may not be performable at the location L of the task T, thereby reducing the list of second class labels 154 to a modified list of second class labels 158 and the corresponding list of second class probabilities 152 to a modified list of second class probabilities 156.

In some examples, the processor 130 is further configured to provide the modified list of second class labels 158 and the modified list of second class probabilities 156 to the merging algorithm 160 prior to determination of the list of third class probabilities 162 and the list of third class labels 164. The merging algorithm 160 determines the list of third class probabilities 162 and the list of third class labels 164 based at least on the modified list of second class probabilities 156. Thus, the merging algorithm 160 may consider the modified list of the second class probabilities 156 and modified list of the second class labels 158 for generating the list of third class probabilities 162 and the list of third class labels 164. The processor 130 may then determine the task T corresponding to the predetermined period of time P based at least on the list of third class probabilities 162.

By combining the location L of the task T and the time required to perform the task T (based on the information related to timestamps of the images I and/or the audio signal 122), the processor 130 may determine an entire workflow the vehicle 108 may go through within the workplace 102, including the tasks T performed, the location L of the tasks T, the time required to conduct those tasks T, an idle time for the vehicle 108 (e.g., no task being performed on the vehicle 108), tools/supplies required for the tasks T, etc. In some examples, the processor 130 may receive information about the identified vehicles 108, the workers 106, the tools/equipment etc. from the first trained machine learning model 140 based on processing of the images I.

In some examples, the processor 130 may track a movement of the vehicle 108 within the workplace 102. For example, the processor 130 may determine whether the vehicle 108 has been moved to a scheduled location (e.g., whether movement of the vehicle 108 satisfies a schedule), whether the vehicle 108 is moved between the same zones 104 a threshold quantity of times (e.g., between a maintenance bay and a quality assurance bay, thereby indicating poor performance of the tasks T), whether the vehicle 108 has moved a threshold distance or has spent a threshold amount of time in transit between different zones 104 of the workplace 102, thereby indicating a bottleneck or inefficient movement within the workplace 102 and/or deviation from a scheduled route through the workplace 102, etc. In some examples, the processor 130 may determine parts or portions of the vehicle 108 being worked upon as part of the task T (e.g., panels repaired/replaced, engine maintenance, panels painted, etc.). In some examples, the processor 130 may determine a global task (e.g., painting) based on a sequence or a series of the tasks T (e.g., sanding, polishing, etc.).

In some examples, the processor 130 may perform an analysis related to workers 106 identified in the images I of the workplace 102 or the zones 104. For example, the processor 130 may analyze movement of the workers 106 in the workplace 102 or the zones 104 and around the tools/equipment or the vehicles 108. In some examples, the processor 130 may determine whether the worker 106 is leaving the zone 104 for a threshold amount of time, whether the worker 106 makes multiple trips to a particular zone 104 during a time period, whether the worker 106 moves around the vehicles 108 in an efficient manner (e.g., in a general direction with a threshold quantity of changes in direction, at a threshold speed, etc.), and/or the like.

In some examples, the processor 130 may determine arrival of ordered parts based on objects identified in the images I of the workplace 102 or the zones 104. Further, the system 100 may allow reduction in time spent looking for the ordered parts. In some examples, the system 100 may help in placing order for required parts or components based on image analysis of an inventory.

Additionally, or alternatively, the processor 130 may determine an amount of time the worker 106 spends performing the task T. Further, the processor 130 may determine whether an amount of time that the worker 106 spends performing the task T satisfies a threshold, whether an amount of time for the task T exceeds an average amount of time for the worker 106 or for other workers 106. In some examples, the processor 130 may identify tasks T that require a threshold amount of time on average (e.g., indicating that the task T is a bottleneck task), and/or the like. Additionally, or alternatively, the processor 130 may determine a location of the worker 106. Further, the processor 130 may determine whether the worker 106 is in an assigned location (e.g., a particular zone 104), whether a threshold quantity of workers 106 is in a particular zone 104 (e.g., indicating that too many workers 106 are in that particular zone 104 and/or are engaged in a particular task T), and/or the like.

In some examples, the processor 130 may determine an amount of time needed to perform the task T. For example, the processor 130 may determine utilization of the zone 104. In other words, the processor 130 may determine a percentage of time during working hours that the zone 104 is being used, whether an amount of time that the zone 104 is being used satisfies a threshold, an average amount of time the zones 104 are being used, whether a schedule is on-time for the zone 104 or across zones 104, and/or the like. In some examples, the processor 130 may determine an amount of time elapsed from the reception of the vehicle 108 inside the workplace 102 until the vehicle 108 moves out of the workplace 102 after service/repair.

In some examples, the aforementioned parameters may allow improved utilization and planning of shared resources (e.g., the workers 106, the tools, the zones 104, etc.) within the workplace 102. In some examples, the system 100 may help plan the tasks T based on the aforementioned parameters since the system 100 may have prior knowledge of the tools and workers 102 required for each task T and the average time required to perform the task T. For example, the system 100 may allow prioritization of the tasks T to be performed on various vehicles 108 based on utilization of a specific tool on different vehicles 108. Additionally, this may help determine the need to purchase an additional/second/improved piece of equipment/tool, hire more workers 102, or acquire additional space based on bottlenecks and utilization of different resources.

In some implementations, the processor 130 may determine a score. For example, the processor 130 may determine a score for the worker 106, the task T, and/or the vehicle 108. In some examples, the score may indicate a result of performing the task T. For example, the score may indicate whether the worker 106 is performing particular activities for a threshold amount of time during a work day, whether the zone 104 is being utilized for a threshold amount of time during a work day, whether maintenance on the vehicle 108 is progressing according to a schedule, and/or the like.

The aforementioned parameters may be used by the processor 130 to calculate various performance metrics (e.g., revenue, throughput, expenses, profitability, efficiency, etc.) for the workplace 102. In some examples, the performance metrics for the workplace 102 may be compared with the performance metrics of other similar workplaces 102 to determine inefficiencies that exist in the workplace 102. Further, the processor 130 may provide recommendations to eliminate those inefficiencies. As the described in the example shown in FIG. 1, the workplace 102 is a vehicle repair and maintenance shop. In such cases, the performance metrics for the workplace 102 may be utilized by insurance companies for evaluation of different workplaces 102.

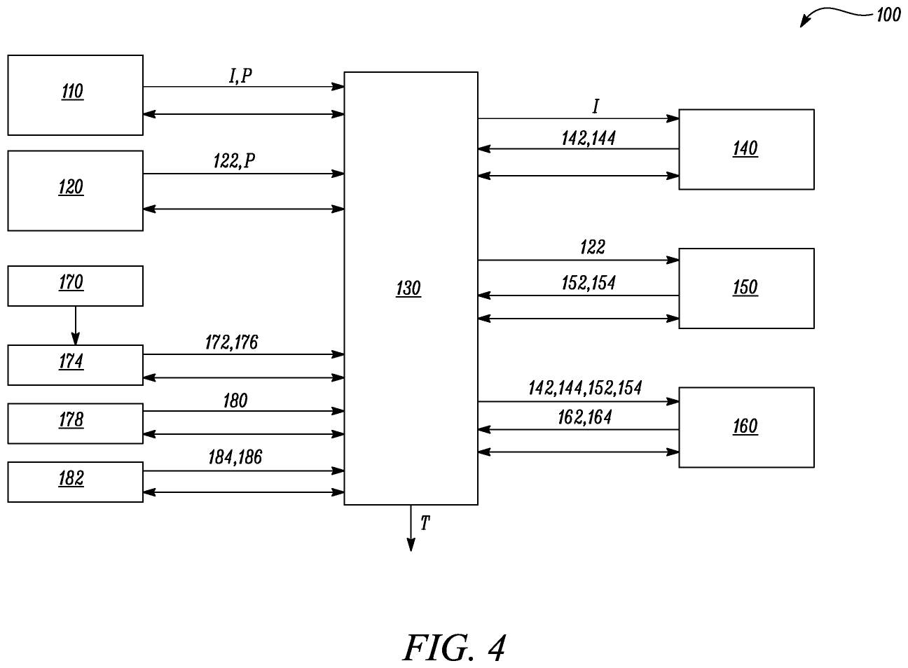

FIG. 4 is a schematic block diagram illustrating another example of the system 100. Referring to FIGS. 1 and 4, in some examples, the system further includes a tool 170 for performing the task T. For example, the tool 170 may be any tool (e.g., a drill, an orbital sander, a paint spray gun, a tire pressure monitoring system, etc.) for performing the task T.

In some examples, the system 100 further includes at least one sensor 174 coupled to the tool 170 and communicably coupled to the processor 130. The term “at least one sensor 174” is interchangeably referred to hereinafter as the “sensor 174”. In some examples, the at least one sensor 174 may include, but not limited to, an accelerometer, a radio frequency identification (RFID) tag, etc.

In some examples, the at least one sensor 174 is configured to generate a sensor signal 176. The sensor signal 176 may be indicative of the task T being performed by the tool 170. For example, the RFID tag associated with the tool 170 may be indicative of the type of tool 170 being used to perform the task T (e.g., by reading the RFID tag). In some examples, the accelerometer may sense a signature (e.g., a vibration, an orientation, a shock, etc.) associated with the tool 170 being used to perform the task T. For example, the tool 170 may cause vibrations of a specific amplitude and a specific frequency while performing the task T (pounding with a hammer, grinding, use of an angle grinder, use of an orbital sander) that may be sensed by the sensor 174.

In some examples, the sensor signal 176 is received by the processor 130. In some examples, the processor 130 is further configured to determine the task T corresponding to the predetermined period of time P further based on the sensor signal 176. Thus, the processor 130 may determine the task T based on inputs from the sensor 174 coupled to the tool 170.

Alternatively, the tool 170 may be any smart tool capable of sending and receiving data by way of one or more wired and/or wireless communication interfaces. In some examples, the wireless communication interface may communicate data via one or more wireless communication protocols, such as Bluetooth, infrared, Wi-Fi, WiMax, cellular communication (3G, 4G, LTE, 5G), wireless universal serial bus (USB), radio frequency, near-field communication (NFC), private licensed bands, or generally any wireless communication protocol.

In some examples, the at least one sensor 174 is further configured determine a time period of operation 172 of the tool 170. In some examples, the processor 130 is further configured to determine the task T corresponding to the predetermined period of time P further based on the time period of operation 172 of the tool 170. The time period of operation 172 of the tool 170 may be an indicator of the task T (e.g., a sanding operation, a drilling operation, etc.) being performed by the tool 170. Alternatively, the time period of operation 172 may be used to eliminate some of the class labels (i.e., the first class labels 144 and/or the second class labels 154) that may not be performable within the determined time period of operation 172. Thus, the processor 130 may determine the task T based on inputs from the sensor 174 coupled to the tool 170.

In some examples, the system 100 further includes a personal protective equipment (PPE) article 178 communicably coupled to the processor 130 and configured to generate a PPE signal 180. The task T involves the PPE article 178. For example, the worker 106 may employ the PPE article 178 while performing the task T.

In some examples, the PPE article 178 may be used to protect a user (e.g., the worker 106) from harm or injury from a variety of factors in the workplace 102. Examples of the PPE article 178 may include, but are not limited to, respiratory protection equipment with or without integrated communication system (including disposable respirators, reusable respirators, powered air purifying respirators, non-powered air purifying respirators, full-face respirators, half-mask respirators, supplied air respirators, self-contained breathing apparatus, etc.), protective eyewear (with or without communication function), such as visors, goggles, filters or shields (any of which may include augmented reality functionality), protective headwear (with or without hearing protection), such as hard hats, hoods or helmets, hearing protection (including in ear hearing protection, ear plugs and ear muffs), protective shoes, protective gloves, other protective clothing, such as coveralls and aprons, protective articles, such as sensors, safety tools, detectors, global positioning devices, and any other suitable gear configured to protect the user from injury. As used herein, the term “protective equipment” may include any type of equipment or clothing that may be used to protect a wearer from hazardous or potentially hazardous conditions.

In some examples, the PPE article 178 may be capable of sending and receiving data by way of one or more wired and/or wireless communication interfaces. In some examples, the wireless communication interface may communicate data via one or more wireless communication protocols, such as Bluetooth, infrared, Wi-Fi, WiMax, cellular communication (3G, 4G, LTE, 5G), wireless universal serial bus (USB), radio frequency, near-field communication (NFC), private licensed bands, or generally any wireless communication protocol.

In some examples, the PPE signal 180 may be indicative of the type of PPE article 178 being used by the worker 106 for performing the task T. Thus, use of the PPE article 178 may be indicative of the task T performed by the worker 106. In some examples, the processor 130 receives the PPE signal 180 from the PPE article 178. In some examples, the processor 130 is further configured to determine the task T corresponding to the predetermined period of time P further based on the PPE signal 180.

In some examples, the system 100 further includes at least one environmental sensor 182 communicably coupled to the processor 130 and configured to generate an environmental signal 184 indicative of an environmental parameter 186 associated with the task T. In some examples, the at least one environmental sensor 182 may be at least one of a temperature sensor and an optical sensor. For example, the optical sensor may sense light produced during a welding operation, the temperature sensor may sense temperature rise during a paint cycle, etc. Alternatively, the optical sensor may sense an opacity or a level of suspended particulates in the air in the workplace 102 or the zones 104 (shown in FIG. 1) resulting from the task T which produces dust or other suspended particles, for example, a sanding operation. In some examples, the processor 130 is further configured to determine the task T corresponding to the predetermined period of time P further based on the environmental signal 184.

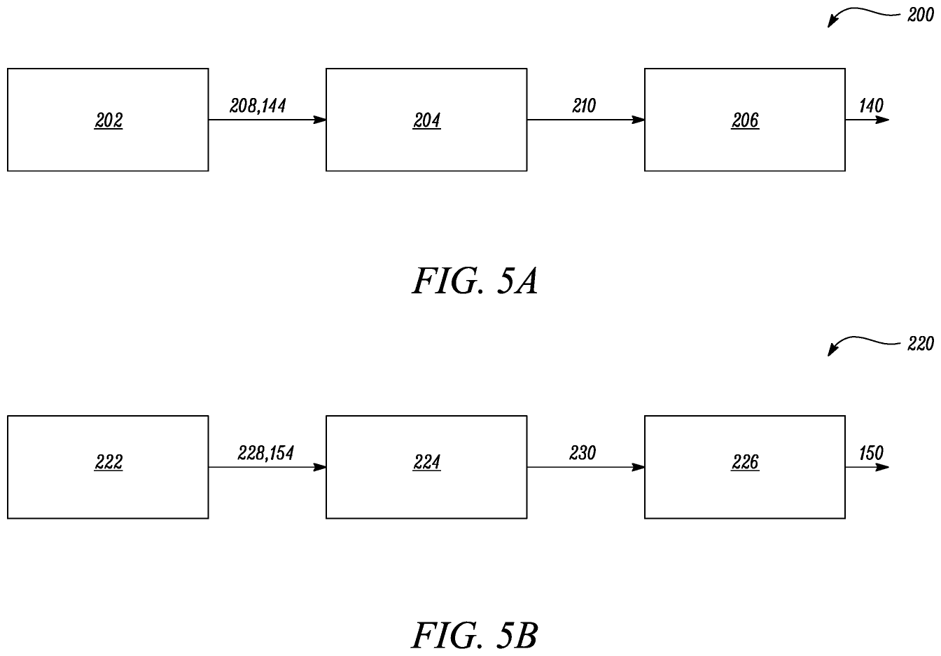

FIG. 5A is a flow chart illustrating a method 200 for training the first trained machine learning model 140 (shown in FIGS. 2-4). At step 202, the method 200 includes receiving a set of labelled images 208. In some examples, the set of labelled images 208 includes a corresponding first task label 144 indicative of a potential task. For example, the set of labelled images 208 may include images of the tasks T (shown in FIG. 1) being performed in the workplace 102 or the zones 104 (shown in FIG. 1) and the set of labelled images 208 includes the corresponding first task label 144. The first task label 144 may represent the task T (shown in FIG. 1) being performed in the corresponding set of labelled images 208.

In some examples, the set of labelled images 208 may also include images of an object (e.g., a tool/equipment), the worker 106 (shown in FIG. 1), and/or the like. In some examples, the set of labelled images 208 may include hundreds, thousands, millions, etc. of data elements and/or images. In some examples, the set of labelled images 208 may be processed (e.g., prior to being used to train the first trained machine learning model 140). For example, one or more labelled images 208 from the set of labelled images 208 may be processed using an image processing and/or augmentation technique to reduce blur in the image, to sharpen the image, to crop the image, to rotate the image, and/or the like.

At step 204, the method 200 further includes providing the set of labelled images 208 to a first machine learning algorithm 210. At step 206, the method 200 further includes generating the first trained machine learning model 140 (shown in FIGS. 2-4) through the first machine learning algorithm 210. In some examples, the first machine learning algorithm 210 may include a predetermined architecture and parameters for generating the first trained machine learning model 140.

It should be understood that other data sources may be also used for generating the first trained machine learning model 140. For example, data associated with vehicles such as number plate, make/model, manufacturer, class of vehicle, etc. may be utilized for generating the first trained machine learning model 140. Other data sources such as severity of repair, repair order/estimate (e.g., line items of damage to repair), etc. may also be utilized.

FIG. 5B is a flow chart illustrating a method 220 for training the second trained machine learning model 150 (shown in FIGS. 2-4). At step 222, the method 200 includes receiving a set of labelled audio clips 228. In some examples, each labelled audio clip 228 includes a corresponding second task label 154 indicative of a sound produced in the workplace 102 (shown in FIG. 1). For example, the set of labelled audio clips 228 may include signature audio clips corresponding to the tasks T (shown in FIG. 1) being performed within the workplace 102 (shown in FIG. 1) and each labelled audio clip 228 from the set of labelled audio clips 228 includes the corresponding second task label 154. The second task label 154 may represent the task T (shown in FIG. 1) being performed in the corresponding labelled audio clip 228.

At step 224, the method 220 further includes providing the set of labelled audio clips 228 to a second machine learning algorithm 230. At step 226, the method 220 further includes generating the second trained machine learning model 150 (shown in FIGS. 2-4) through the second machine learning algorithm 230. In some examples, the second machine learning algorithm 230 may include a predetermined architecture and parameters for generating the second trained machine learning model 150 (shown in FIGS. 2-4).

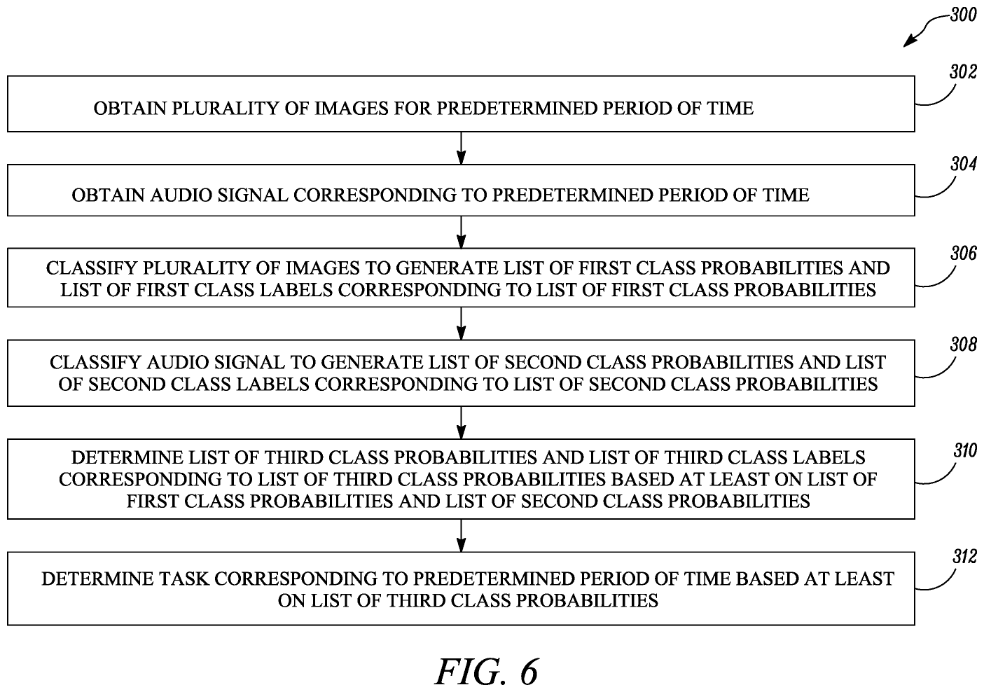

FIG. 6 is a flow chart illustrating a method 300 of classifying the task T in the workplace 102. The method 300 may be implemented using the system 100 described with reference to FIGS. 1-4. It should be understood that steps of the method 300 are not necessarily presented in any particular order and that performance of some or all the steps in an alternative order(s) is possible and is contemplated. The steps have been presented in the demonstrated order for ease of description and illustration. Further, it should be understood that steps can be added, omitted and/or performed simultaneously without departing from the scope of the appended claims. Moreover, it should also be understood that the illustrated method 300 can be ended at any time.

At step 302, the method 300 includes obtaining, via the at least one image capturing device 110, the plurality of images I for the predetermined period of time P. At step 304, the method 300 further includes obtaining, via the at least one audio sensor 120, the audio signal 122 corresponding to the predetermined period of time P.

At step 306, the method 300 further includes classifying, via the first trained machine learning model 140, the plurality of images I to generate the list of first class probabilities 142 and the list of first class labels 144 corresponding to the list of first class probabilities 142. Each first class probability 142 is indicative of a probability of the corresponding first class label 144 being the task T.

At step 308, the method 300 further includes classifying, via the second trained machine learning model 150, the audio signal 122 to generate the list of second class probabilities 152 and the list of second class labels 154 corresponding to the list of second class probabilities 152. Each second class probability 152 is indicative of a probability of the corresponding second class label 154 being the task T.

At step 310, the method 300 further includes determining, via the merging algorithm 160, the list of third class probabilities 162 and the list of third class labels 164 corresponding to the list of third class probabilities 162 based at least on the list of first class probabilities 142 and the list of second class probabilities 152. Each third class probability 162 is indicative of a probability of the corresponding third class label 164 being the task T.

At step 312, the method 300 further includes determining, via the processor 130, the task T corresponding to the predetermined period of time P based at least on the list of third class probabilities 162.

In some examples, the method 300 further includes determining, via the processor 130, the location L of the task T within the workplace 102. In some examples, the location L of the task T within the workplace 102 is determined based on the predetermined location L1 of the at least one image capturing device 110 and/or the predetermined location L2 of the at least one audio sensor 130. In some examples, determining the location L of the task T within the workplace 102 further includes determining, via the first trained machine learning model 140, the location L of the task T based on the plurality of images I.

In some examples, the method 300 further includes determining, via the processor 130, the plurality of predetermined tasks T1 performable within the location L. In some examples, the method 300 further includes determining the task T corresponding to the predetermined period of time P further based on an overlap between the list of third class labels 164 and the plurality of predetermined tasks T1 performable within the location L.

In some examples, the method 300 further includes modifying, via the processor 130, the list of first class labels 144 and the list of first class probabilities 142 received from the first trained machine learning model 140 by removing one or more first class labels 144 from the list of first class labels 144 that are absent in the plurality of predetermined tasks T1 performable within the location L and removing the corresponding one or more first class probabilities 142 from the list of first class probabilities 142.

In some examples, the method 300 further includes providing, via the processor 130, the modified list of first class labels 148 and the modified list of first class probabilities 146 to the merging algorithm 160 prior to determination of the list of third class probabilities 162 and the list of third class labels 164. In some examples, the merging algorithm 160 determines the list of third class probabilities 162 and the list of third class labels 164 based at least on the modified list of first class probabilities 146.

In some examples, the method 300 further includes modifying, via the processor 130, the list of second class labels 154 and the list of second class probabilities 152 received from the second trained machine learning model 150 by removing one or more second class labels 154 from the list of second class labels 154 that are absent in the plurality of predetermined tasks T1 performable within the location L and removing the corresponding one or more second class probabilities 152 from the list of second class probabilities 152.

In some examples, the method 300 further includes providing, via the processor 130, the modified list of second class labels 158 and the modified list of second class probabilities 156 to the merging algorithm 160 prior to determination of the list of third class probabilities 162 and the list of third class labels 164. In some examples, the merging algorithm 160 determines the list of third class probabilities 162 and the list of third class labels 164 based at least on the modified list of second class probabilities 156.

In some examples, the method 300 further includes obtaining, via the at least one sensor 174, the sensor signal 176. The at least one sensor 174 is coupled to the tool 170. In some examples, the method 300 further includes determining the task T corresponding to the predetermined period of time P further based on the sensor signal 176.

In some examples, the method 300 further includes determining, via the at least one sensor 174, the time period of operation 172 of the tool 170. In some examples, the method 300 further includes determining the task T corresponding to the predetermined period of time P further based on the time period of operation 172 of the tool 170.

In some examples, the method 300 further includes obtaining, via the PPE article 178, the PPE signal 180. The task T involves the PPE article 178. In some examples, the method 300 further includes determining the task T corresponding to the predetermined period of time P further based on the PPE signal 180.

In some examples, the method 300 further includes obtaining, via the at least one environment sensor 182, the environmental signal 184. The environmental signal 184 is indicative of the environmental parameter 186 associated with the task T. In some examples, the method 300 further includes determining the task T corresponding to the predetermined period of time P further based on the environmental signal 184.

The method 300 may allow automatic identification of the task T within the workplace 102 based on the classification of the plurality of images I and the audio signal 122. This may reduce a need to manually register/input data associated with the tasks T performed within the workplace 102. The first trained machine learning model 140 and the second trained machine learning model 150 may generate the list of first class labels 144 and the list of second class labels 154 with the associated first class probabilities 142 and the second class probabilities 152, respectively. The merging algorithm 160 may then determine the list of third class labels 164 and the list of third class probabilities 162 based at least on the list of first class probabilities 142 and the list of second class probabilities 152. Thus, the method 300 may allow accurate identification of the task T within the workplace 102 based on multiple inputs, i.e., via the classification of the plurality of images I and the classification of the audio signal 122.

Although FIG. 1 is described with respect to a vehicle repair and/or maintenance facility, the implementations may apply equally to other types of facilities, such as a manufacturing facility, a shipping facility, etc. In addition, the implementations may apply equally to other contexts, such as an analysis of tasks to determine compliance with regulations and/or organization policies, an analysis of tasks to identify potentially hazardous and/or prohibited tasks (e.g., to identify smoke in a facility, to identify placement of an object that blocks an emergency exit, etc.), an analysis of tasks to identify usage of safety equipment, and/or the like.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A method of classifying a task in a workplace, the method comprising:
obtaining, via at least one image capturing device, a plurality of images for a predetermined period of time;
obtaining, via at least one audio sensor, an audio signal corresponding to the predetermined period of time;
classifying, via a first trained machine learning model, the plurality of images to generate a list of first class probabilities and a list of first class labels corresponding to the list of first class probabilities, wherein each first class probability is indicative of a probability of the corresponding first class label being the task;
classifying, via a second trained machine learning model, the audio signal to generate a list of second class probabilities and a list of second class labels corresponding to the list of second class probabilities, wherein each second class probability is indicative of a probability of the corresponding second class label being the task;
determining, via a merging algorithm, a list of third class probabilities and a list of third class labels corresponding to the list of third class probabilities based at least on the list of first class probabilities and the list of second class probabilities, wherein each third class probability is indicative of a probability of the corresponding third class label being the task; and
determining, via a processor, the task corresponding to the predetermined period of time based at least on the list of third class probabilities.

2. The method of claim 1, further comprising:
determining, via the processor, a location of the task within the workplace; and
determining, via the processor, a plurality of predetermined tasks performable within the location.

3. The method of claim 2, further comprising:
modifying, via the processor, the list of first class labels and the list of first class probabilities received from the first trained machine learning model by removing one or more first class labels from the list of first class labels that are absent in the plurality of predetermined tasks performable within the location and removing the corresponding one or more first class probabilities from the list of first class probabilities; and
providing, via the processor, the modified list of first class labels and the modified list of first class probabilities to the merging algorithm prior to determination of the list of third class probabilities and the list of third class labels, wherein the merging algorithm determines the list of third class probabilities and the list of third class labels based at least on the modified list of first class probabilities.

4. The method of claim 2, further comprising:
modifying, via the processor, the list of second class labels and the list of second class probabilities received from the second trained machine learning model by removing one or more second class labels from the list of second class labels that are absent in the plurality of predetermined tasks performable within the location and removing the corresponding one or more second class probabilities from the list of second class probabilities; and
providing, via the processor, the modified list of second class labels and the modified list of second class probabilities to the merging algorithm prior to determination of the list of third class probabilities and the list of third class labels, wherein the merging algorithm determines the list of third class probabilities and the list of third class labels based at least on the modified list of second class probabilities.

5. The method of claim 2, wherein determining the task corresponding to the predetermined period of time further based on an overlap between the list of third class labels and the plurality of predetermined tasks performable within the location.

6. The method of claim 2, wherein the location of the task within the workplace is determined based on a predetermined location of the at least one image capturing device and/or a predetermined location of the at least one audio sensor.

7. The method of claim 2, wherein determining the location of the task within the workplace further comprises determining, via the first trained machine learning model, the location of the task based on the plurality of images.

8. The method of claim 2, wherein the location comprises a plurality of zones.

9. The method of claim 1, further comprising:
obtaining, via at least one sensor, a sensor signal, wherein the at least one sensor is coupled to a tool, and wherein the task is performed by the tool; and
determining the task corresponding to the predetermined period of time further based on the sensor signal.

10. The method of claim 9, further comprising:
determining, via the at least one sensor, a time period of operation of the tool; and
determining the task corresponding to the predetermined period of time further based on the time period of operation of the tool.

11. The method of claim 1, further comprising:
obtaining, via a personal protective equipment (PPE) article, a PPE signal, wherein the task involves the PPE article; and
determining the task corresponding to the predetermined period of time further based on the PPE signal.

12. The method of claim 1, further comprising:
obtaining, via at least one environment sensor, an environmental signal, wherein the environmental signal is indicative of an environmental parameter associated with the task; and
determining the task corresponding to the predetermined period of time further based on the environmental signal.

13. The method of claim 1, further comprising:
receiving a set of labelled images, wherein the set of labelled images comprises a corresponding first task label indicative of a potential task;
providing the set of labelled images to a first machine learning algorithm; and
generating the first trained machine learning model through the first machine learning algorithm.

14. The method of claim 1, further comprising:
receiving a set of labelled audio clips, wherein each labelled audio clip comprises a corresponding second task label indicative of a sound produced within the workplace;
providing the set of labelled audio clips to a second machine learning algorithm; and
generating the second trained machine learning model through the second machine learning algorithm.

15. A system for classifying a task in a workplace, the system comprising:
at least one image capturing device configured to capture a plurality of images for a predetermined period of time;
at least one audio sensor configured to capture sound waves corresponding to the predetermined period of time and generate an audio signal based on the captured sound waves;
a processor communicably coupled to the at least one image capturing device and the at least one audio sensor, wherein the processor is configured to obtain the plurality of images from the at least one image capturing device and the audio signal from the at least one audio sensor;
a first trained machine learning model communicably coupled to the processor, wherein the first trained machine learning model is configured to classify the plurality of images to generate a list of first class probabilities and a list of first class labels corresponding to the list of first class probabilities, and wherein each first class probability is indicative of a probability of the corresponding first class label being the task;
a second trained machine learning model communicably coupled to the processor, wherein the second trained machine learning model is configured to classify the audio signal to generate a list of second class probabilities and a list of second class labels corresponding to the list of second class probabilities, and wherein each second class probability is indicative of a probability of the corresponding second class label being the task; and
a merging algorithm communicably coupled to the processor, wherein the merging algorithm is configured to generate a list of third class probabilities and a list of third class labels corresponding to the list of third class probabilities based at least on the list of first class probabilities and the list of second class probabilities, and wherein each third class probability is indicative of a probability of the corresponding third class label being the task;
wherein the processor is further configured to determine the task corresponding to the predetermined period of time based at least on the list of third class probabilities.

16. The system of claim 15, wherein the processor is further configured to:
determine a location of the task within the workplace; and
determine a plurality of predetermined tasks performable within the location.

17. The system of claim 16, wherein the processor is further configured to:
modify the list of first class labels and the list of first class probabilities received from the first trained machine learning model by removing one or more first class labels from the list of first class labels that are absent in the plurality of predetermined tasks performable within the location and removing the corresponding one or more first class probabilities from the list of first class probabilities; and
provide the modified list of first class labels and the modified list of first class probabilities to the merging algorithm prior to determination of the list of third class probabilities and the list of third class labels, wherein the merging algorithm determines the list of third class probabilities and the list of third class labels based at least on the modified list of first class probabilities.

18. The system of claim 16, wherein the processor is further configured to:
modify the list of second class labels and the list of second class probabilities received from the second trained machine learning model by removing one or more second class labels from the list of second class labels that are absent in the plurality of predetermined tasks performable within the location and removing the corresponding one or more second class probabilities from the list of second class probabilities; and
provide the modified list of second class labels and the modified list of second class probabilities to the merging algorithm prior to determination of the list of third class probabilities and the list of third class labels, wherein the merging algorithm determines the list of third class probabilities and the list of third class labels based at least on the modified list of second class probabilities.

19. The system of claim 16, wherein the processor is further configured to determine the task corresponding to the predetermined period of time further based on an overlap between the list of third class labels and the plurality of predetermined tasks performable within the location.

20. The system of claim 16, wherein the processor is further configured to determine the location of the task within the workplace based on a predetermined location of the at least one image capturing device and/or a predetermined location of the at least one audio sensor.
